(19) United States
(12) Patent Application Publication
(10) Pub. No.: US 2014/0136660 A1
(43) Pub. Date: May 15, 2014

(54) EXTENDING MULTICAST/BROADCAST SERVICES TO WIDE AREA NETWORKS

(71) Applicant: Benu Networks, Inc., Billerica, MA (US)

(72) Inventors: Rajat GHAI, Sandwich, MA (US); David F. CALLAN, Swampscott, MA (US); Rajendar DUGGAL, Lincoln, MA (US); Swarup SAHOO, Acton, MA (US); Shawn LEWIS, Orlando, FL (US); John DEPIETRO, Sandwich, MA (US)

(73) Assignee: BENU NETWORKS, INC., Billerica, MA (US)

(21) Appl. No.: 14/077,561

(22) Filed: Nov. 12, 2013

Related U.S. Application Data
(60) Provisional application No. 61/725,370, filed on Nov. 12, 2012.

(51) Int. Cl. H04L 29/08

(52) U.S. Cl. CPC H04L 67/02
USPC 709/219

(57) ABSTRACT

Systems and methods are described for extending multicast/broadcast service to wide area networks. A computerized method includes receiving a multicast/broadcast discovery message from a client, encapsulating the multicast/broadcast discovery message at a gateway, forwarding the encapsulated multicast/broadcast discovery message to a multicast/broadcast server, receiving a multicast/broadcast discovery response message from the multicast/broadcast server with a server IP address, generating a server alias IP address for the multicast/broadcast server at the gateway, replacing the server IP address with the server alias IP address in the multicast/broadcast discovery response message, encapsulating the multicast/broadcast discovery response message at the gateway, and forwarding the encapsulated multicast/broadcast discovery response message to the client.

### RELATED APPLICATIONS

This application claims priority to U.S. Provisional Patent Application No. 61/725,370 filed on Nov. 12, 2012, the content of which is incorporated herein by reference in its entirety.

### BACKGROUND

“Content” in a networking environment can include information and experiences that may provide information and values for an end user audience. Content may be delivered via any medium such as the Internet, TVs, and audio CDs, as well as live events such as conferences and stage performances. Content may be provided by service providers like broadcast cable companies and ISPs, as well wireless service providers through subscription services. Words may be used to identify and quantify various formats and genres of information as manageable value-adding components of media. Generally, the term “media file” can refer to a file in which “content” is contained. In various embodiments, a “media file” may include a movie, television (TV) show, audiobook, e-book, music, etc. Generally, media (movies or audiobooks, etc.) may be streamed from a media company's content server to a user's device (e.g., computer, smartphone, etc.). When streaming media, the user is expected to consume (e.g., watch, listen to, etc.) the media immediately. The media is generally not cached (although some buffering may occur) and if the media is not consumed it is removed from the user's device. Further, in order for the media file to be streamed the user's device and the content server must generally maintain communication for the duration of the streaming of the media file. If the network connection between the two devices is lost for an extended period of time, the streaming will normally cease. Examples of such media streaming services include DVR, Tivo, iTunes movie rentals, Hulu, Netflix's Instant Watch, Amazon's Video on Demand (VoD), and Pandora, etc.

Cloud computing is a model for enabling ubiquitous, convenient, on-demand network access to a shared pool of configurable computing resources (e.g., networks, servers, storage, applications, and services) that can be rapidly provisioned and released with minimal management effort or service provider interaction.

A cloud infrastructure is the collection of hardware and software that enable the five essential characteristics of cloud computing, namely on-demand self-service, broad network access, resource pooling, rapid elasticity, and measured service. The cloud infrastructure can be viewed as containing both a physical layer and an abstraction layer. The physical layer can consist of the hardware resources that are necessary to support the cloud services being provided, and can typically include server, storage and network components. The abstraction layer can consist of the software deployed across the physical layer, which can manifest the essential cloud characteristics. Conceptually the abstraction layer can sit above the physical layer. Cloud infrastructure and computing can create operational efficiencies and configuration flexibility due to aggregation and polling of resources that are shared by end users/devices.

Service providers can provide cloud services to their subscribers over variety of access networks (AN). Basic categorization of access networks include wireline (also called fixed broadband) and wireless (also known as mobile networks). Wireline networks can comprise of cable, DSL and optical access networks etc. Wireless access networks can comprise of WiFi, 3G, 4G access networks, etc.

A Public Land Mobile Network (PLMN) is generally a wireless network operated by recognized and authorized organizations called wireless service providers. A PLMN can use radio waves in licensed spectrum to create a telecommunication network for providing mobile telecommunications service to the public. A mobile service can provide continuous connectivity amongst mobile devices or between mobile devices to a fixed network.

PLMNs can use cellular telephony that is generally characterized by the use of radio cells that provide radio coverage for a geographic area, with multiple cells arranged to provide contiguous radio coverage over a larger area. Wired communication can be used in portions of a PLMN, such as between cells, access points, or gateways to create entry/exit points to the Internet. A typical PLMN can include an access network (AN) that is specific to wireless technologies and a core network (CN) that performs routing of mobile communication within the PLMN or from PLMN to extern packet data networks (PDN), e.g., the Internet.

PLMNs have evolved over the years following the advancements in cellular technologies. The first generation (1G) cellular technology used analog mobile phones in which analog information signals were modulated and transmitted. The second generation (2G) systems used digital modulation of the information signals to provide more dense and robust wireless systems. Among the many 2G wireless technologies, the most prevalent ones used code division multiple access (CDMA) technologies for IS-95 systems or time division multiplex access (TDMA) technology for GSM systems to distinguish multiple users. 2G wireless networks are primarily used for speech communication. With the advent of the Internet and the demand to access the Internet from portable mobile devices, CDMA based networks were further upgraded to handle higher-speed packet data using CDMA 1x-EVDO in networks referred to as 2.5G while GSM based networks were upgraded to GPRS/EDGE and then HSPA as 3G networks. 3G networks are evolving to 4G technology, which is referred to as long term evolution-system architecture evolution (LTE-SAE) and uses orthogonal frequency division multiple access (OFDMA) technology. Other 4G wireless technologies have also developed including WiMAX (an implementation of IEEE 802.16), Wi-Fi (an implementation of various IEEE 802.11 protocols), and HiperMAN, which is based on an ETSI alternative to IEEE 802.16. 4G networks are based on IP (Internet Protocol) technology to facilitate ultrafast IP packet transmission services.

The range of the wireless communication technology can vary depending on the deployment of the PLMN. A macro cell transceiver is typically used by service providers to provide coverage over about three miles. A pico cell transceiver can provide coverage over about a quarter mile while a femto cell transceiver can provide coverage over 50 to 100 yards that is similar in coverage to a Wi-Fi (WLAN) access point and can be used to provide network access over a short range.

PLMNs use wireless communication technologies to provide speech and data communication services to mobile/portable devices e.g. laptop and notebook computers with many applications (e.g. web browsers to access the Internet), portable digital assistants (PDAs), and bespoke mobile devices (e.g., cellular telephones, user equipment). Users, authorized for the wireless service, can connect to a network (e.g., the Internet) as long as the user is within range of such a wireless communication technology.

For the PLMNs, a part of the evolution of packet based communications has been the development of a core network capable of routing IP based data communication within a PLMN (mobile to mobile) or PLMN to an external network (e.g. mobile to the Internet). IP packet core network functionality can be developed by three different groups for inclusion in two different topologies: Global System for Mobile Communications (GSM), CDMA 2000, and WiMAX. The 3^{rd} Generation Partnership Project (3GPP) is responsible for General Packet Radio Service (GPRS) which works with GSM/LTE systems, the 3rd Generation Partnership Project 2 (3GPP2) is responsible for High Rate Packet Data (HRPD) which is used with CDMA systems and WiMAX forum responsible for Access Service Network (ASN) and Connectivity Service Network (CSN).

For 3G UMTS based technologies, such a packet core network is referred to as GPRS (General packet radio service) CN. GPRS is an architectural framework for delivering internet protocol (IP) transmission services to mobile nodes. Main components of a GPRS core network that provide packet services are a SGSN (Serving GPRS Service Node) and a GGSN (Gateway GPRS Service Node). A SGSN manages initial authentication, authorization, mobility, IP session establishment and charging aspects of packet data communications for the mobile nodes. A GGSN manages IP address allocation to the mobile nodes, gathers charging details for the amount of data packets transmitted by the mobile nodes, enforces policies of the PLMN operator, and provides connectivity to external packet data networks (PDNs) such as the Internet.

For LTE based technologies, such a packet core network is referred to as Evolved Packet Core (EPC). EPC is an architectural framework for delivering internet protocol (IP) transmission services to mobile nodes. Main components of an EPC core network that provide packet services are a Mobility Management Entity (MME), a Serving Gateway (SGW), and a PDN Gateway (PGW). The MME manages initial authentication, authorization, mobility, IP session establishment and charging aspects of packet data communications for the mobile nodes. The SGW and PGW manage IP address allocation to the mobile nodes, gather charging details for the amount of data packets transmitted by the mobile nodes, enforce policies of the PLMN operator, and provide connectivity to external packet data networks (PDNs). In a CDMA based HRPD core network, the Packet Data Service Node (PDSN) and Home Agent (HA) provide the architectural framework for delivering internet protocol (IP) transmission services to the mobile node. In a WiMAX core network, Access Service Network Gateway (ASN-GW), Core Service Network Gateway (CSN GW), or HA provides the architectural framework for delivering IP transmission services to the mobile node. In a WiFi core network, the Wi-GW (Wireless Access Gateway) provides the architectural framework for delivering IP transmission services to the mobile node.

The Digital Living Network Alliance (DLNA) is a non-profit collaborative trade organization that is responsible for defining interoperability guidelines to enable sharing of digital media between multimedia devices. These guidelines are generally built upon existing public standards and specify a set of restricted ways of using the standards to achieve interoperability, and include almost all free audio formats and the most common (free or otherwise) video formats. DLNA can use Universal Plug and Play (UPnP) for media management, discovery, and control. UPnP can define the type of devices that DLNA supports (“server,” “renderer,” or “controller”) and the mechanisms for accessing media over a network. The DLNA guidelines can then apply a layer of restrictions over the types of media file format, encodings, and resolutions that a device must or should support.

Universal Plug and Play (UPnP) is an industry standard (www.upnp.org) that generally specifies a set of networking protocols that permit networked devices, such as personal computers, TVs, media servers, Network Attached Storage servers (NAS), printers, Internet gateways, Wi-Fi access points, and mobile devices to seamlessly discover each other's presence on a local area network (LAN) and establish functional network services for data sharing, communications, and entertainment. UPnP is generally intended primarily for residential networks in a private, home based LAN environment. UPnP standards have been adopted by other industry consortiums like DLNA. The UPnP Forum is a computer industry initiative to enable simple and robust connectivity to stand-alone devices and personal computers from many different vendors. In a home LAN environment, for example, the concept of UPnP is an extension of plug-and-play, a technology for dynamically attaching devices directly to a computer, although UPnP is not directly related to the earlier plug-and-play technology. UPnP devices can be “plug-and-play” in that when connected to a network they can automatically establish working configurations with other devices. Other technologies also exist to achieve the similar objective. Some examples include Real Time Streaming Protocol (RTSP) or Bonjour.

In conventional systems, however, these technologies (UPnP, Bonjour, or RTSP, etc.) normally only operate within a local network (e.g., a home LAN) and do not work beyond the boundary of a local network or in wide area networks.

### SUMMARY

In accordance with the disclosed subject matter, systems and methods are described for extending multicast/broadcast service to wide area networks.

Disclosed subject matter includes, in one aspect, a computerized method, which includes receiving a multicast/broadcast discovery message from a client, encapsulating the multicast/broadcast discovery message at a gateway, forwarding the encapsulated multicast/broadcast discovery message to a multicast/broadcast server, receiving a multicast/broadcast discovery response message from the multicast/broadcast server with a server IP address, generating a server alias IP address for the multicast/broadcast server at the gateway, replacing the server IP address with the server alias IP address in the multicast/broadcast discovery response message, encapsulating the multicast/broadcast discovery response message at the gateway, and forwarding the encapsulated multicast/broadcast discovery response message to the client.

In some embodiments, the multicast/broadcast server is a DLNA (Digital Living Network Alliance)-compatible server, the multicast/broadcast discovery message is a DLNA discovery message, and the multicast/broadcast discovery response message is a DLNA discovery response message.

In some embodiments, the multicast/broadcast discovery message is encapsulated with an outer destination address and an outer source address.

In some embodiments, the multicast/broadcast discovery message is encapsulated in a tunnel managed by the gateway.

In some embodiments, the tunnel is a Generic Routing Encapsulation (GRE) tunnel.

In some embodiments, the multicast/broadcast discovery response message is encapsulated with an outer destination address and an outer source address.

In some embodiments, the multicast/broadcast discovery response message is encapsulated in a tunnel managed by the gateway.

In some embodiments, the tunnel is a Generic Routing Encapsulation (GRE) tunnel.

In some embodiments, the client is within a local network behind the gateway and the multicast/broadcast server is outside the local network.

In some embodiments, the multicast/broadcast server is within a local network behind the gateway and the client is outside the local network.

Disclosed subject matter includes, in another aspect, a computerized method, which includes receiving a multicast/broadcast control package message from a client with a server alias IP address of a multicast/broadcast server, replacing the server alias IP address in the multicast/broadcast control package message with a server IP address of the multicast/broadcast server at a gateway, forwarding the multicast/broadcast control package message to the multicast/broadcast server based on the server IP address, receiving a multicast/broadcast control package response message from the multicast/broadcast server with the server IP address, replacing the server IP address in the multicast/broadcast control package response message with the server alias IP address, and forwarding the replaced multicast/broadcast control package response message to the client.

In some embodiments, the multicast/broadcast server is a DLNA (Digital Living Network Alliance)-compatible server, the multicast/broadcast control package message includes a HTTP Get message, and the multicast/broadcast control package response message includes a HTTP Response message.

In some embodiments, the computerized method further includes removing encapsulation of the multicast/broadcast control package message.

In some embodiments, the encapsulation is in a tunnel managed by the gateway.

In some embodiments, the tunnel is a Generic Routing Encapsulation (GRE) tunnel.

In some embodiments, the computerized method further includes encapsulating the multicast/broadcast control package response message with an outer destination address and an outer source address before forwarding the multicast/broadcast control package response message to the client.

In some embodiments, the multicast/broadcast control package response message is encapsulated in a tunnel managed by the gateway.

In some embodiments, the tunnel is a Generic Routing Encapsulation (GRE) tunnel.

In some embodiments, the client is within a local network behind the gateway and the multicast/broadcast server is outside the local network.

In some embodiments, the multicast/broadcast server is within a local network behind the gateway and the client is outside the local network.

Disclosed subject matter includes, in yet another aspect, a network gateway serving as a multicast/broadcast proxy, which includes an access network interface configured to receive a multicast/broadcast message from a client destined to a multicast/broadcast server, a router network interface configured to forward the multicast/broadcast message to the multicast/broadcast server, a multicast/broadcast server database containing information about available multicast/broadcast servers, an address translation module configured to translate between a server IP address and a server alias IP address of the multicast/broadcast server in the multicast/broadcast message, and an encapsulation module configured to encapsulate the multicast/broadcast message and remove encapsulation from an encapsulated multicast/broadcast message.

In some embodiments, the network gateway further includes a configuration manager configured to set up the network gateway.

In some embodiments, the configuration manage is configured to set at least one of a Gateway Access IP address and a Gateway Router IP address.

In some embodiments, the multicast/broadcast message is a multicast/broadcast discovery message.

In some embodiments, the multicast/broadcast message is a multicast/broadcast control package message.

In some embodiments, the multicast/broadcast server is a DLNA (Digital Living Network Alliance)-compatible server.

In some embodiments, the client is within a local network behind the network gateway and the multicast/broadcast server is outside the local network.

In some embodiments, the multicast/broadcast server is within a local network behind the network gateway and the client is outside the local network.

Various embodiments of the subject matter disclosed herein can provide one or more of the following capabilities. The network boundary of multicast/broadcast service has been expanded beyond the local network boundary and to include other local networks and/or remote clouds. A multicast/broadcast service can be extended to wide area networks. A multicast/broadcast server and its client(s) can potentially reside anywhere on any local or wide area networks (e.g., the Internet), as long as they are reachable via a gateway serving as a multicast/broadcast proxy. In one illustrative example, a gateway implementing features of the disclosed subject matter can securely proxy and/or bridge multicast/broadcast service messages (e.g., UPnP protocol messages) over an access network and thus connect a home LAN with content delivery or storage services in a service provider cloud.

These and other capabilities of embodiments of the disclosed subject matter will be more fully understood after a review of the following figures, detailed description, and claims.

### BRIEF DESCRIPTION OF THE DRAWINGS

FIG. 1 illustrates an exemplary local area network (LAN).

FIG. 2 illustrates an exemplary network arrangement.

FIG. 3 illustrates an exemplary multicast/broadcast network arrangement.

FIG. 4 illustrates an exemplary process of tunneling and encapsulation in an multicast/broadcast network arrangement.

FIG. 5 illustrates another exemplary process of tunneling and encapsulation in an multicast/broadcast network arrangement.

FIG. 6 illustrates one exemplary configuration of a gateway as a multicast/broadcast proxy.

FIG. 7 illustrates an exemplary network arrangement where embodiments of the disclosed subject matter are implemented.

FIG. 8 contains a block diagram of an exemplary gateway.

FIG. 9 illustrates an exemplary operation of a gateway.

FIG. 10 illustrates another exemplary operation of the gateway.

FIG. 11 contains a block diagram of an exemplary computing device.

### DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

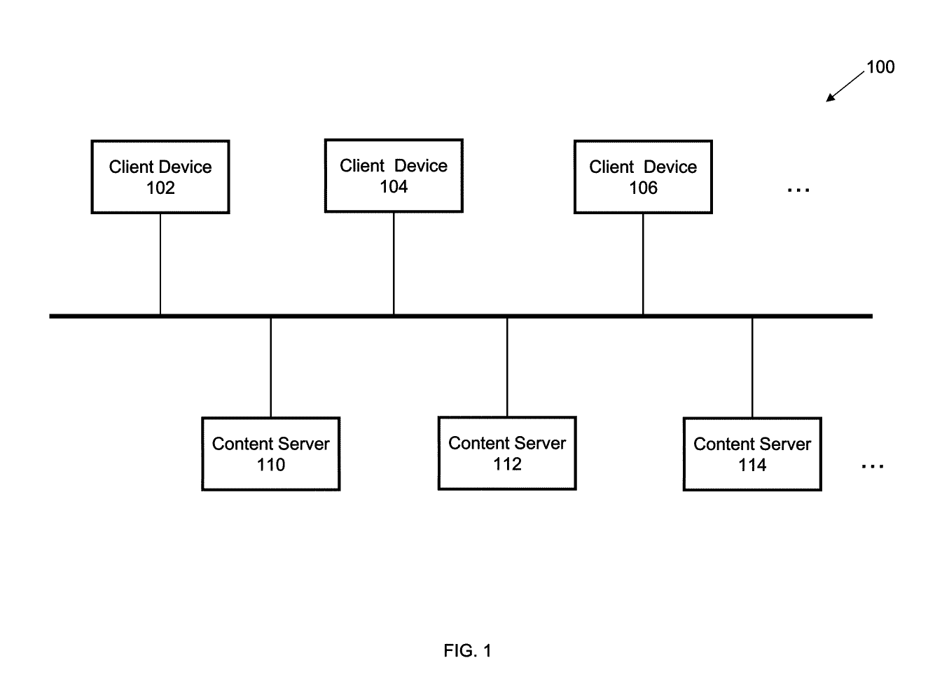

FIG. 1 illustrates an exemplary local area network (LAN) 100 according to some embodiments of the disclosed subject matter. The local network 100 can include one or more client devices 102, 104, and 106, and one or more content servers 110, 112, and 114. The content server (110, 112, and/or 114) can provide content (e.g., media files) to the client devices 102, 104, or 106). Some devices/servers can serve as both a client device and a content server. The client devices and the content servers can be UPnP-compatible. For example, the client devices or content servers can include UPnP-compatible computers, digital cameras, A/V players, TVs, scanners, wireless devices, printers, or digital picture frames. These client devices or content servers can serve as UPnP control points, rendering devices, content directories, and/or I/O devices.

Techniques such as UPnP, Bonjour, or RTSP can rely on a multicast/broadcast mechanism to some extent. For example, before a UPnP client device (e.g., 102 in FIG. 1) can receive a streaming media from a UPnP-compatible content server (e.g., a DLNA server or content server 110 in FIG. 1), the UPnP client device generally can multicast or broadcast a discovery message (e.g., a DLNA discovery message) to the local area network it resides in (e.g., 100 in FIG. 1). Upon receiving the discovery message, the content server can then respond, in order to establish a communication link between the client device and the content server. In the conventional systems, however, the multicast/broadcast service messages do not traverse across the boundary of the local area network. As a result, a multicast/broadcast content server (e.g., a DLNA server) and its client devices (e.g., UPnP client devices) typically reside in the same local area network. If the multicast/broadcast content server resides outside the local area network (e.g., in a wide area network or in a different local area network), multicast/broadcast services such as UPnP usually do not work.

The disclosed subject matter can provide a solution where multicast/broadcast services can be extended to wide area networks. The network boundary of multicast/broadcast service can be expanded beyond the local network boundary and to include other local networks and/or remote clouds. A multicast/broadcast content server and its client(s)/subscriber(s) can potentially reside anywhere on a wide area network (e.g., the Internet), as long as they are reachable via a gateway serving as a multicast/broadcast proxy. Although specific multicast/broadcast mechanisms (such as UPnP) are referred to in the discussion of various embodiments, the disclosed subject matter is not limited to these specific multicast/broadcast mechanisms.

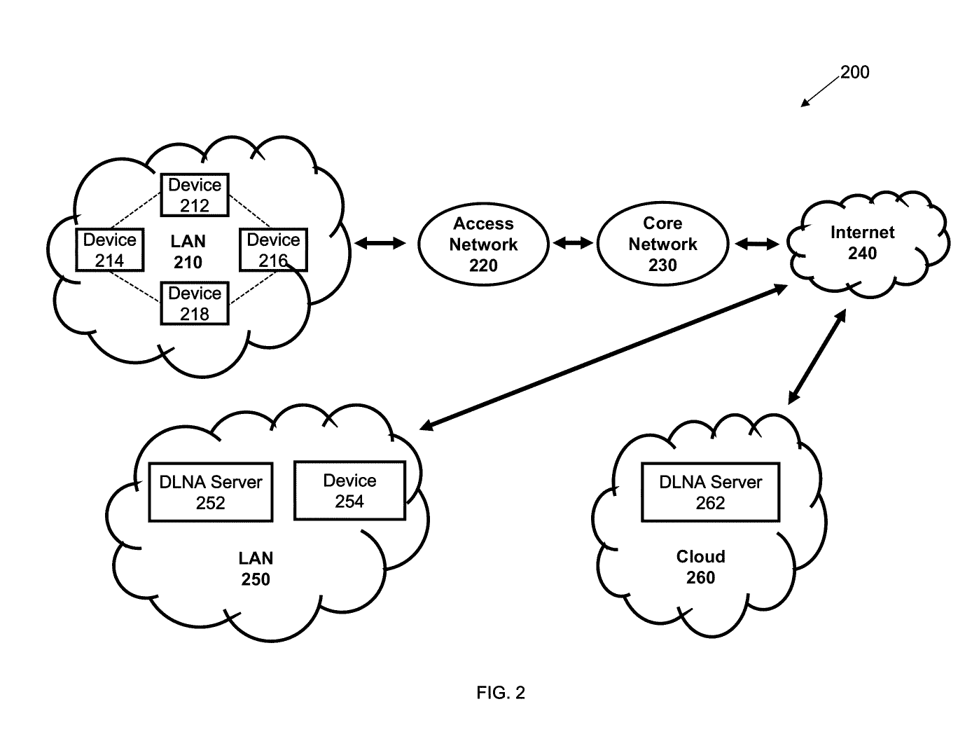

Embodiments of the disclosed subject matter can be implemented in a networked computing environment. FIG. 2 illustrates an exemplary network arrangement 200 in accordance with certain embodiments of the disclosed subject matter. The network arrangement 200 can include a local area network (LAN) 210, an access network 220, a core network 230, an external network such as the Internet 240, another LAN 250, and a cloud 260. The LAN 210 can include one more networked devices 212, 214, 216, and 218, which can be UPnP-compatible clients and/or servers. The LAN 250 can include additional UPnP-compatible devices, such as DLNA server 252 and UPnP client device 254. The cloud 260 can also include additional UPnP-compatible devices, such as DLNA server 262.

The devices or servers 212, 214, 216, 218, 252, 254, and 262 can be any computing device capable of accessing a wired or wireless network. Examples of the devices or servers include desktop computers, portable computers, smartphones, tablets, and any other network capable devices. The access network 220 can be configured to allow one or more devices or servers 212, 214, 216, 218 to access the network arrangement 200. The access network 220 can be implemented in various wired or mobile/wireless technologies. Examples of the access network 220 include a Wi-Fi access point, a radio base station, a 3G small cell, an eNodeB macro cell, and an eNodeB small cell, etc. The devices 212, 214, 216, 216 can connect to the access network 220 via a network protocol (e.g., IEEE 802.11). The access network 220 can connect to the core network 230 via various interfaces (e.g., an Iu interface, an Generic Routing Encapsulation (GRE) interface, an Si interface, etc.). The core network 230 can then connect to the external network such as the Internet 240. In the network arrangement 200, the access network 220 can be functionally separated from the core network 230, allowing them to be implemented in various technologies independently.

In a conventional networking environment similar to the network arrangement 200, multicast/broadcast client devices 212, 214, 216, 218 are unable to access the multicast/broadcast content servers such as DLNA servers 252 and 262 via UPnP protocol because the multicast/broadcast content servers such as DLNA servers 252 or 262 are outside the LAN 210 where the multicast/broadcast client devices 212, 214, 216, 218 reside.

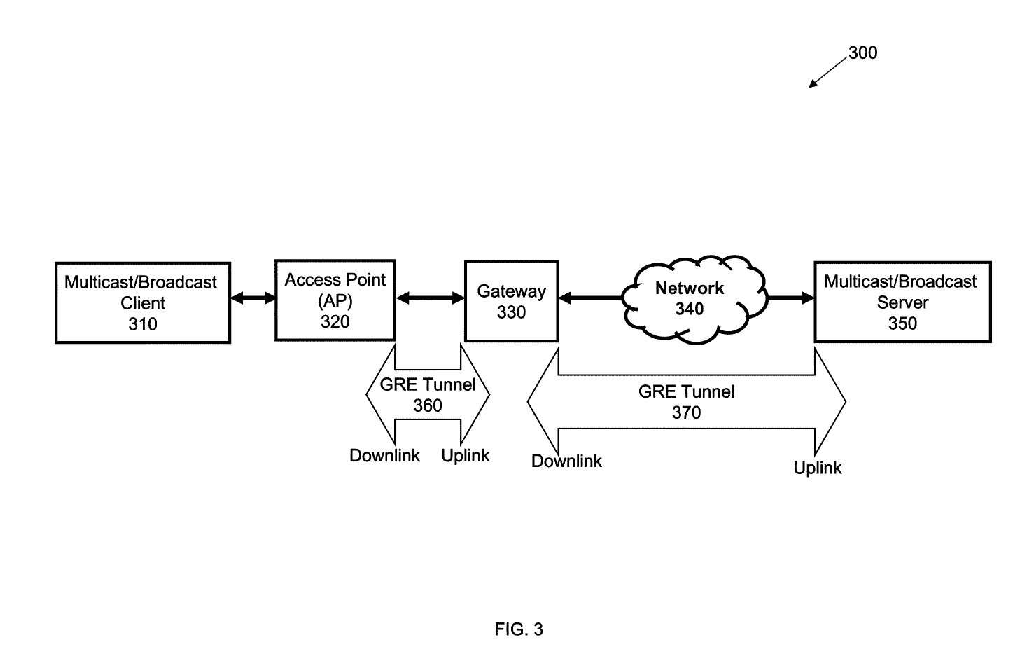

FIG. 3 illustrates an exemplary multicast/broadcast network arrangement 300 in accordance with certain embodiments of the disclosed subject matter. The network arrangement 300 can include a multicast/broadcast client 310, an access point 320, a gateway 330, a network 340, and a multicast/broadcast server 350. The multicast/broadcast client 310 can first connect to the access point (AP) 320, which can be part of an access network (e.g., 220 in FIG. 2). The access point can then connect to the gateway 330, which can be part of a core network (e.g., 230 in FIG. 2). In some embodiments, the gateway 330 can be an wireless access gateway (WAG). The gateway 330 can connect to the multicast/broadcast server 350, either directly or via the network 340. In some embodiments, the multicast/broadcast client 310 can be an UPnP-compatible client device; the multicast/broadcast server 350 can be an UPnP-compatible content server, such as a DLNA server.

Still referring to FIG. 3, the gateway 330 can create tunneling (e.g., GRE tunnels 360 and 370) between the multicast/broadcast client 310 and the multicast/broadcast server 350. The gateway 330 can encapsulate discovery, control, or data messages to/from the multicast/broadcast client 310 and the multicast/broadcast server 350. The tunneling and encapsulation can allow multicast/broadcast service messages to travel between the multicast/broadcast client 310 and the multicast/broadcast server 350, which may or may not reside on the same local area network. In some embodiments, the gateway 330 can server as a multicast/broadcast proxy between the multicast/broadcast client 310 and the multicast/broadcast server 350.

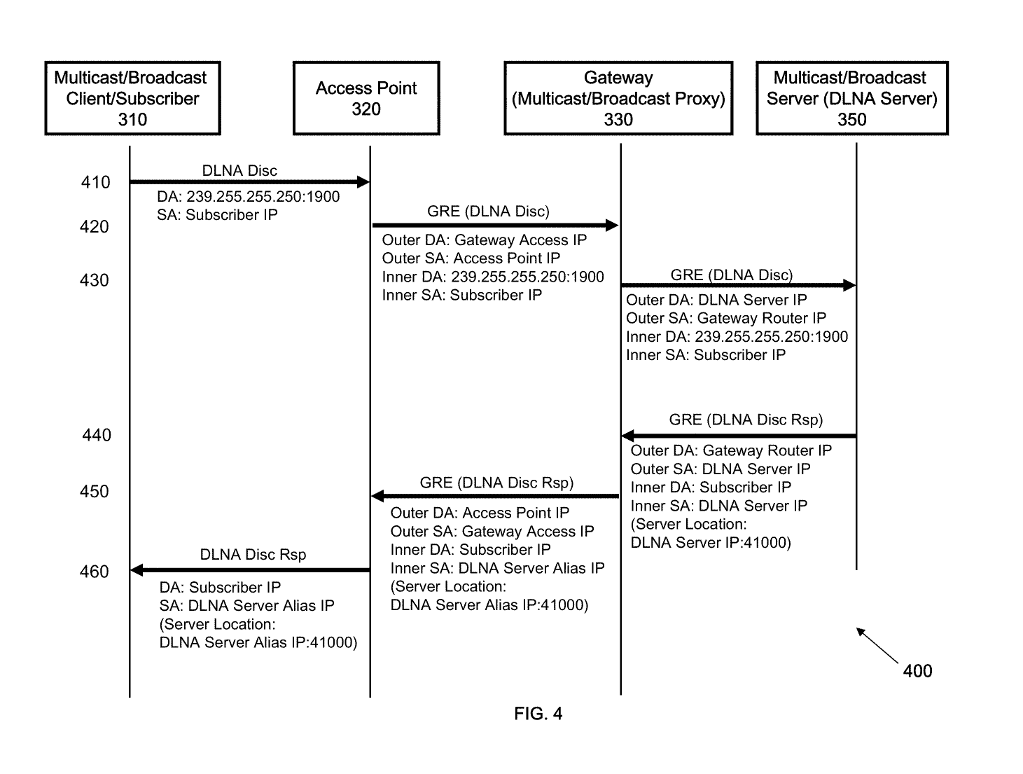

FIG. 4 illustrates an exemplary process 400 of tunneling and encapsulation in an multicast/broadcast network arrangement in accordance with certain embodiments of the disclosed subject matter. The process 400 can be modified by, for example, having stages rearranged, changed, added and/or removed.

At stage 410, the multicast/broadcast client/subscriber 310 sends a multicast/broadcast discovery message. For example, the multicast/broadcast client/subscriber 310 can send a DLNA Disc message. The destination address in the DLNA Disc message can be 239.255.255.250:1900. The source address of the DLNA Disc message can be the client/subscriber's IP address.

At stage 420, the access point 320 receives the multicast/broadcast discovery message from the multicast/broadcast client/subscriber 310 and forwards the multicast/broadcast discovery message to the gateway 330 via a tunnel (e.g., GRE) created and managed by the gateway 330. In some embodiments, the access point 320 can encapsulate the received multicast/broadcast discovery message and send the encapsulated multicast/broadcast discovery message to the gateway 330. For example, the destination address in an encapsulated DLNA Disc message can be the gateway 330's Gateway Access IP address. The source address of the encapsulated DLNA Disc message can be the access point 320's IP address. Inside the encapsulation, the destination address can remain as 239.255.255.250:1900 and the source address can remain as the client/subscriber's IP address.

At stage 430, the gateway 330 receives the multicast/broadcast discovery message from the access point 320 and forwards the multicast/broadcast discovery message to the multicast/broadcast server 350 (e.g., a DLNA server) via a tunnel (e.g., GRE) created and managed by the gateway 330. In some embodiments, the gateway can serve as a multicast/broadcast proxy between the multicast/broadcast client 310 and the multicast/broadcast server 350. In some embodiment, the gateway 330 can encapsulate the received multicast/broadcast discovery message and send the encapsulated multicast/broadcast discovery message to the multicast/broadcast server 350. For example, the destination address in the encapsulated DLNA Disc message can be the multicast/broadcast server 350's IP address. The source address of the encapsulated DLNA Disc message can be the gateway 330's Gateway Router IP address. Inside the encapsulation, the destination address can remain as 239.255.255.250:1900 and the source address can remain as the client/subscriber's IP address.

At stage 440, the multicast/broadcast 340 receives the multicast/broadcast discovery message from the gateway 330 and generates a multicast/broadcast discovery response message destined to multicast/broadcast server client/subscriber 310. The multicast/broadcast discovery response message can be sent to the gateway 330 via the tunnel (e.g., GRE) created by the gateway 330. In some embodiments, the gateway can serve as a multicast/broadcast proxy between the multicast/broadcast client 310 and the multicast/broadcast server 350. In some embodiment, the multicast/broadcast server 350 can encapsulate the multicast/broadcast discovery response message and send the encapsulated multicast/broadcast discovery response message to the gateway 330. For example, the destination address in an encapsulated DLNA Disc Rsp message can be the gateway 330's Gateway Router IP address. The source address of the encapsulated DLNA Disc Rsp message can be the multicast/broadcast server 350's IP address. Inside the encapsulation, the real destination address can be the multicast/broadcast client/subscriber's IP address; the real source address can be the multicast/broadcast server's IP address. In this example, the DLNA server's location can be identified as “DLNA Server IP:41000.”

At stage 450, the gateway 330 receives the multicast/broadcast discovery response message from the multicast/broadcast server 350 and forwards an modified multicast/broadcast discovery response message to the multicast/broadcast client/subscriber 310 through the access point 320. The modified multicast/broadcast discovery response message can be sent to the access point 320 via the tunnel (e.g., GRE) created and managed by the gateway 330. In some embodiments, the gateway can serve as a multicast/broadcast proxy between the multicast/broadcast client 310 and the multicast/broadcast server 350. In some embodiments, the gateway 330 can encapsulate the multicast/broadcast discovery response message and send the encapsulated multicast/broadcast discovery response message to the access point 320. The gateway 330 can also generate an alias IP address for the multicast/broadcast server 350, e.g., based on the real IP address of the multicast/broadcast server 350. The gateway 330 can use the generated alias IP in the encapsulated multicast/broadcast discovery response message. The gateway 330 can also maintain the relationship between the alias IP addresses and the real IP addresses of multicast/broadcast servers. For example, the destination address in an encapsulated DLNA Disc Rsp message can be the access point 320's IP address. The source address of the encapsulated DLNA Disc Rsp message can be the gateway 330's Gateway Access IP address. Inside the encapsulation, the real destination address can be the multicast/broadcast client/subscriber's IP address; the modified real source address can be the multicast/broadcast server's alias IP address. In this example, the DLNA server's location can be identified as “DLNA Server IP:41000” outside the gateway 330 but be identified as “DLNA Server Alias IP:41000” inside the gateway 330.

At stage 460, the access point 320 receives the encapsulated multicast/broadcast discovery response message from the gateway 330 and forwards the modified multicast/broadcast discovery response message to the multicast/broadcast client/subscriber 310 without encapsulation. For example, the access point 320 can remove the encapsulation and forward the DLNA Disc Rsp message to the multicast/broadcast client/subscriber 310. The destination address in the DLNA Disc Rsp message can be the multicast/broadcast client/subscriber 310's IP address. The source address of the DLNA Disc Rsp message can be the multicast/broadcast server 350's alias IP address. In this example, from the view of multicast/broadcast client/subscriber 310, the DLNA server's location can be identified as “DLNA Server Alias IP:41000.”

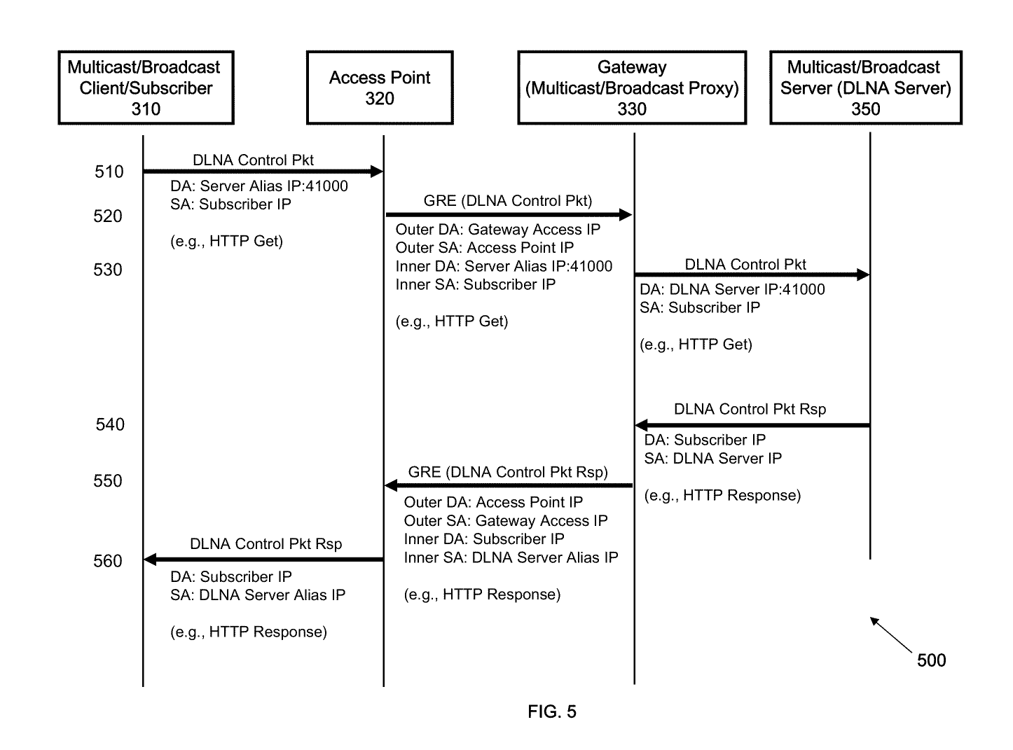

FIG. 5 illustrates an exemplary process 500 of tunneling and encapsulation in an multicast/broadcast network arrangement in accordance with certain embodiments of the disclosed subject matter. The process 500 can be modified by, for example, having stages rearranged, changed, added and/or removed.

At stage 510, the multicast/broadcast client/subscriber 310 sends a multicast/broadcast control package message. For example, the multicast/broadcast client/subscriber 310 can send a DLNA Control Pkt message. The destination address in the DLNA Control Pkt message can be a multicast/broadcast server's alias IP address that was discovered earlier (e.g., as in FIG. 4). The source address of the DLNA Control Pkt message can be multicast/broadcast client/subscriber's IP address. In this example, the destination address is set to “DLNA Server Alias IP:41000.” In some embodiments, the multicast/broadcast control package message can include a HTTP Get message.

At stage 520, the access point 320 receives the multicast/broadcast control package message from the multicast/broadcast client/subscriber 310 and forwards the multicast/broadcast control package message to the gateway 330 via a tunnel (e.g., GRE) created and managed by the gateway 330. In some embodiments, the access point 320 can encapsulate the received multicast/broadcast control package message and send the encapsulated multicast/broadcast control package message to the gateway 330. For example, the destination address in an encapsulated DLNA Control Pkt message can be the gateway 330's Gateway Access IP address. The source address of the encapsulated DLNA Control Pkt message can be the access point 320's IP address. Inside the encapsulation, the destination address can remain as Server Alias IP:41000 and the source address can remain as the client/subscriber's IP address.

At stage 530, the gateway 330 receives the multicast/broadcast control package message from the access point 320 and forwards the multicast/broadcast control package message to the multicast/broadcast server 350 (e.g., a DLNA server). In some embodiments, the gateway can serve as a multicast/broadcast proxy between the multicast/broadcast client 310 and the multicast/broadcast server 350. In some embodiments, the multicast/broadcast control package message can be sent to the multicast/broadcast server 350 directly without encapsulation. In some embodiment, the gateway 330 can perform address translation for the multicast/broadcast server 350 and update the destination address of the multicast/broadcast control package message. For example, the destination address in the updated DLNA Control Pkt message can be set to the multicast/broadcast server 350's real IP address. The source address of the DLNA Control Pkt message can be the client/subscriber's IP address.

At stage 540, the multicast/broadcast server 350 receives the multicast/broadcast control package message from the gateway 330 and generates a multicast/broadcast control package response message destined to multicast/broadcast server client/subscriber 310. In some embodiments, the gateway can serve as a multicast/broadcast proxy between the multicast/broadcast client/subscriber 310 and the multicast/broadcast server 350. In some embodiments, the multicast/broadcast control package response message can be sent to the gateway 330 directly without encapsulation. For example, the destination address in the DLNA Control Pkt Rsp message can be the multicast/broadcast client/subscriber 310's IP address. The source address of the DLNA Control Pkt Rsp message can be the multicast/broadcast server 350's real IP address. In this example, the DLNA server's location can be identified as “DLNA Server IP.” In some embodiments, the multicast/broadcast control package response message can include a HTTP Response message. For example, the HTTP Response message can contain a directory/list of contents available on the multicast/broadcast server 350. The available contents can be common to some or all clients or customized for individual clients.

At stage 550, the gateway 330 receives the multicast/broadcast control package response message from the multicast/broadcast server 350 and forwards an modified multicast/broadcast control package response message to the multicast/broadcast client/subscriber 310 through the access point 320. The modified multicast/broadcast discovery response message can be sent to the access point 320 via the tunnel (e.g., GRE) created and managed by the gateway 330. In some embodiments, the gateway can serve as a multicast/broadcast proxy between the multicast/broadcast client 310 and the multicast/broadcast server 350. In some embodiments, the gateway 330 can encapsulate the multicast/broadcast discovery response message and send the encapsulated multicast/broadcast control package response message to the access point 320 via the tunnel (e.g., GRE) created by the gateway 330. In some embodiment, the gateway 330 can perform address translation for the multicast/broadcast server 350 and update the destination address of the multicast/broadcast control package message. For example, the destination address in an encapsulated DLNA Control Pkt Rsp message can be the access point 320's IP address. The source address of the encapsulated DLNA Control Pkt Rsp message can be the gateway 330's Gateway Access IP address. Inside the encapsulation, the real destination address can be the multicast/broadcast client/subscriber's IP address; the updated source address can be the multicast/broadcast server's alias IP address. In this example, the DLNA server's location can be identified as “DLNA Server IP” outside the gateway 330 but be identified as “DLNA Server Alias IP” inside the gateway 330.

At stage 560, the access point 320 receives the encapsulated multicast/broadcast control package response message from the gateway 330 and forwards the modified multicast/broadcast control package response message to the multicast/broadcast client/subscriber 310 without encapsulation. For example, the access point 320 can remove the encapsulation and forward the DLNA Control Pkt Rsp message to the multicast/broadcast client/subscriber 310. The destination address in the DLNA Control Pkt Rsp message can be the multicast/broadcast client/subscriber 310's IP address. The source address of the DLNA Control Pkt Rsp message can be the multicast/broadcast server 350's alias IP address. In this example, from the view of multicast/broadcast client/subscriber 310, the DLNA server's location can be identified as “DLNA Server Alias IP.”

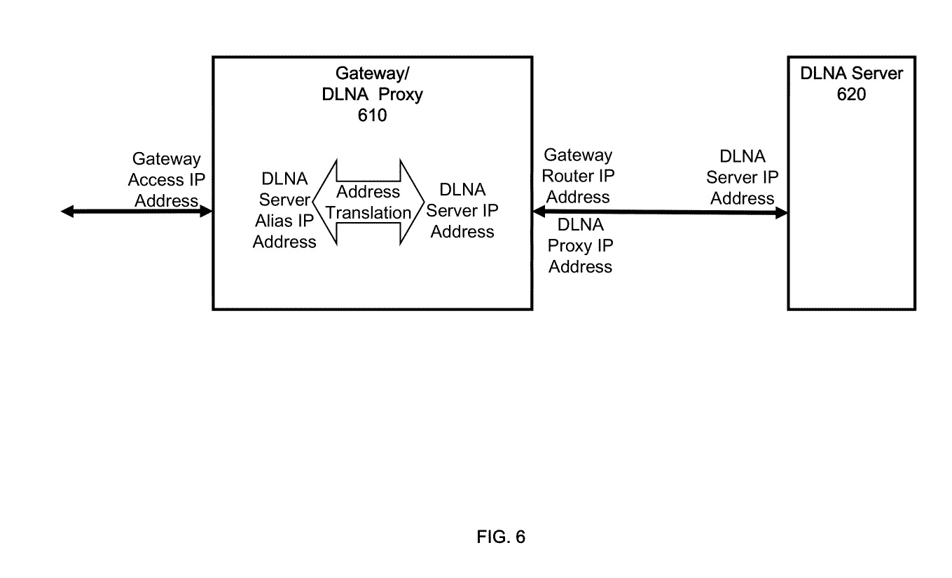

FIG. 6 illustrates one exemplary configuration of a gateway as a multicast/broadcast proxy in accordance with certain embodiments of the disclosed subject matter. In FIG. 6, DLNA server 620 can have a DLNA Server IP address, by which the DLNA server 620 can be addressed and identified by others on the network. Gateway 610 can have at least two network interface addresses, e.g., a Gateway Router IP address and a Gateway Access IP address. From outside, gateway 610 can be addressed and identified by its Gateway Router IP address. From inside, gateway 610 can be addressed and identified by its Gateway Access IP address. As illustrated in FIG. 6, gateway 610 can serve as a proxy between DLNA server 620 and its clients/subscribers (not shown in FIG. 6). From its client/subscriber's view, DLNA server 620 can be addressed and identified by its DLNA Server Alias IP address. Gateway 610 can also perform address translation for DLNA server 620. When gateway 610 serves as a DLNA proxy, gateway 610 can also be addressed and identified by a DLNA Proxy IP address, which can optionally be same as gateway 610's Gateway Router IP address.

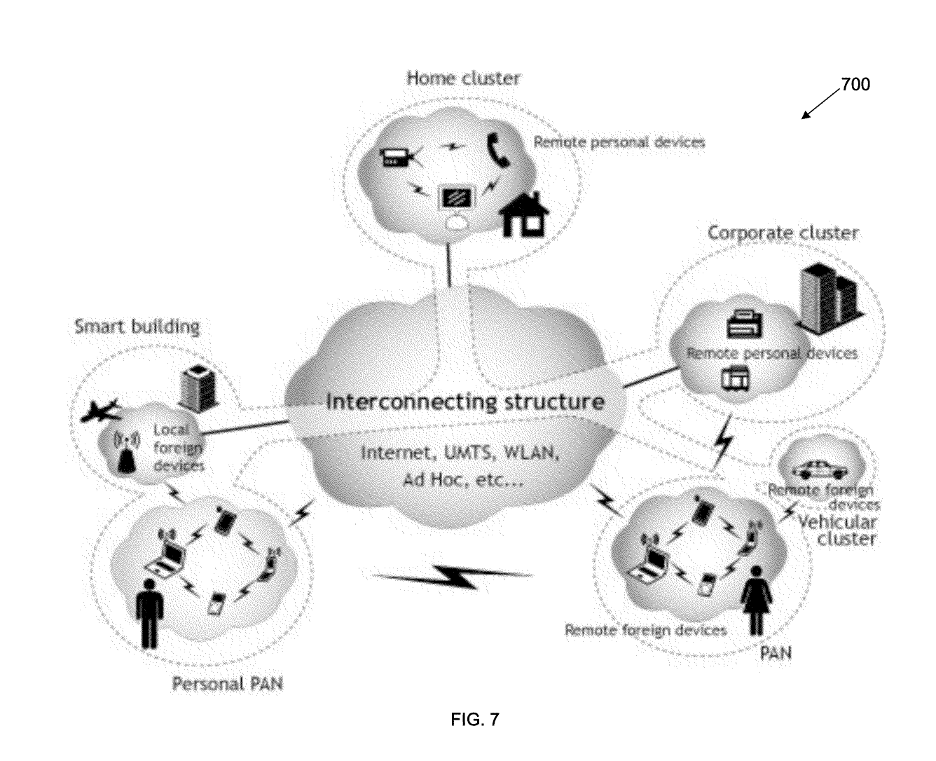

FIG. 7 illustrates an exemplary network arrangement 700 where embodiments of the disclosed subject matter are implemented. In the network arrangement 700, multiple local networks can be connected together through an interconnecting structure and can communicate among each other. Examples of local networks can include a personal PAN (personal area network), a smart building, a home cluster, a corporate cluster, a vehicle cluster, and a PAN. Examples of interconnecting structure can include the Internet, UMTS, WLAN, Ad hoc, etc. Conventionally, a multicast/broadcast server and a multicast/broadcast client have to reside on the same local network. For example, using the network arrangement 700 for illustration, if a multicast/broadcast server resides in the personal PAN, the multicast/broadcast client(s) must reside on the same personal PAN. A client device outside the personal PAN (e.g., in the corporate cluster or the vehicle cluster) is unable to access the multicast/broadcast server in the personal PAN. In contrast, with embodiments of the disclosed subject matter, the local network boundary of multicast/broadcast service can be eliminated. For example, a client device in the corporate cluster or the vehicle cluster can access a multicast/broadcast server inside the personal PAN. Similarly, a client device in the smart building can access the multicast/broadcast server in the corporate cluster. The dotted line in FIG. 7 illustrates that the network boundary of multicast/broadcast service has been expanded beyond the local network boundary and to include other local networks and/or remote clouds. With embodiments of the disclosed subject matter, a multicast/broadcast service can be extended to wide area networks. A multicast/broadcast server and its client(s) can potentially reside anywhere on a wide area network (e.g., the Internet), as long as they are reachable via a gateway serving as a multicast/broadcast proxy.

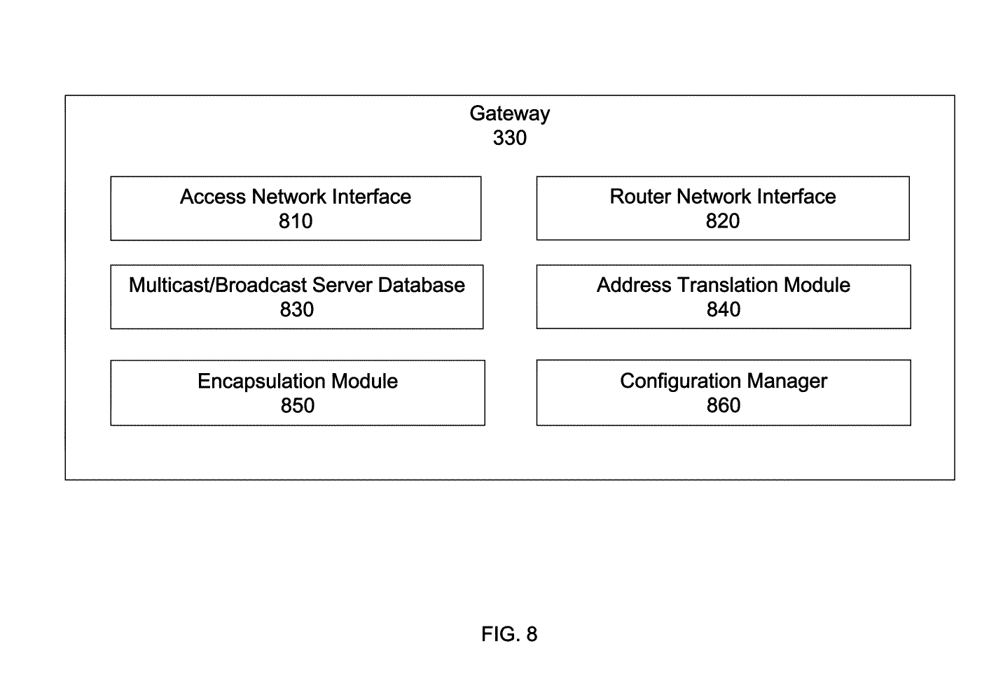

FIG. 8 contains a block diagram of an exemplary gateway 330 in accordance with certain embodiments of the disclosed subject matter. The gateway 330 can include an access network interface 810, a router network interface 820, a multicast/broadcast server database 830, an address translation module 840, an encapsulation module 850, and optionally a configuration manager 860. The gateway 330 can include additional modules, fewer modules, or any other suitable combination of modules that perform any suitable operation or combination of operations. Two or more components can be combined or merged. Certain function can be split among two or more components.

The access network interface 810 can serve as the communication interface between the gateway 330 and networking nodes inside a local network served by the gateway 330. For example, the access network interface 810 can serve as the communication interface between the gateway 330 and an access point (e.g., 320 in FIG. 3). In some embodiments, the access network interface 810 can present a Gateway Access IP address (e.g., illustrated in FIG. 6) for the gateway 330. As discussed earlier, a Gateway Access IP address can be used to address and identify the gateway 330. In some embodiments, the access network interface 810 can be implemented in hardware and/or software running on a general or dedicated processor in the gateway 330.

The router network interface 820 can serve as the communication interface between the gateway 330 and networking nodes outside a local network served by the gateway 330. For example, the router network interface 820 can serve as the communication interface between the gateway 330 and a multicast/broadcast server or the Internet (e.g., 340 or 350 in FIG. 3). In some embodiments, the router network interface 820 can present a Gateway Router IP address (e.g., illustrated in FIG. 6) for the gateway 330. As discussed earlier, a Gateway Router IP address can also be used to address and identify the gateway 330. In some embodiments, the router network interface 820 can be implemented in hardware and/or software running on a general or dedicated processor in the gateway 330.

The multicast/broadcast server database 830 can maintain and manage the available multicast/broadcast servers known to the gateway 330. In some embodiments, the multicast/broadcast server database 830 can be populated and maintained by a system administrator of the gateway 330. In some embodiments, the multicast/broadcast server database 330 can also be updated automatically or periodically based on the past or current accesses to various multicast/broadcast servers. In some embodiments, the multicast/broadcast server database 830 can be implemented in hardware and/or software running on a general or dedicated processor in the gateway 330.

The address translation module 840 can perform address translation. In some embodiments, the address translation module 840 can translate addresses for multicast/broadcast servers. For example, the address translation module 840 can translate between a server IP address and a server alias IP address of a multicast/broadcast server. The address translation module 840 can also maintain or store a database of server IP addresses and server alias IP addresses of known multicast/broadcast servers. The database can keep track of the matching between server IP addresses and server alias IP addresses. One example of such a database is a server IP address-server alias IP address table. In some embodiments, the address translation module 840 can be implemented in hardware and/or software running on a general or dedicated processor in the gateway 330.

The encapsulation module 850 can encapsulate multicast/broadcast messages among multicast/broadcast servers and clients. In some embodiments, the encapsulation module 850 can create and maintain a tunnel for communication among multicast/broadcast servers and clients. For example, the encapsulation module 850 can create and maintain a GRE tunnel. In some embodiments, the encapsulation module 850 can be implemented in hardware and/or software running on a general or dedicated processor in the gateway 330.

The configuration manager 860 can configure the gateway 330 and various components inside the gateway 330. In some embodiments, the configuration manager 860 can configure the gateway 330 based on a system policy and/or user preferences.

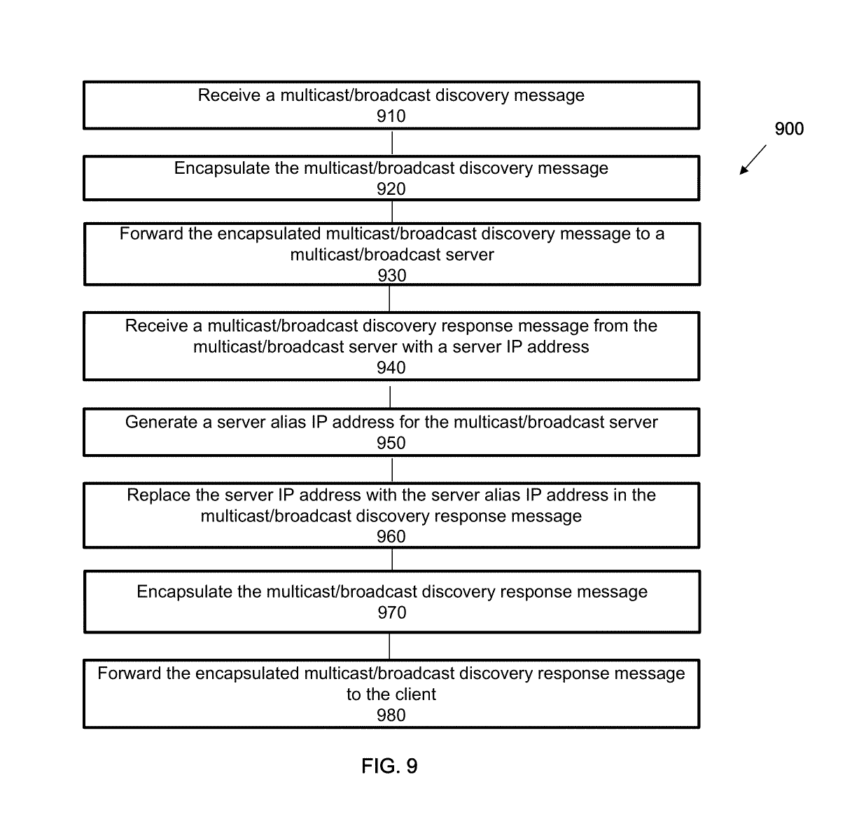

FIG. 9 illustrates an exemplary operation 900 of a gateway according to certain embodiments of the disclosed subject matter. The operation 900 can be modified by, for example, having stages rearranged, changed, added and/or removed.

At stage 910, a multicast/broadcast discovery message can be received from, e.g., a client (such as 310 in FIG. 3). In some embodiments, the multicast/broadcast discovery message can be a DLNA discovery message.

At stage 920, the multicast/broadcast discovery message can be encapsulated at, e.g., a gateway (such as 330 in FIG. 3). In some embodiments, the gateway can serve as a multicast/broadcast proxy. In some embodiments, the multicast/broadcast discovery message can be encapsulated with an outer destination address and an outer source address. The multicast/broadcast discovery message can be encapsulated in a tunnel managed by the gateway. The tunnel can be a Generic Routing Encapsulation (GRE) tunnel.

At stage 930, the encapsulated multicast/broadcast discovery message can be forwarded to, e.g., a multicast/broadcast server (such as 330 in FIG. 3). In some embodiments, the multicast/broadcast server can be a DLNA server.

At stage 940, a multicast/broadcast discovery response message can be received from the multicast/broadcast server with a server IP address. In some embodiments, the multicast/broadcast discovery response message can be a DLNA discovery response message.

At stage 950, a server alias IP address for the multicast/broadcast server can be generated at, e.g., the gateway. In some embodiments, the server alias IP address for the multicast/broadcast server can be generated based on the server IP address.

At stage 960, the server IP address can be replaced with the server alias IP address in the multicast/broadcast discovery response message, e.g., by the gateway (such as 330 in FIG. 3).

At stage 970, the multicast/broadcast discovery response message can be encapsulated at, e.g., the gateway (such as 330 in FIG. 3). In some embodiments, the multicast/broadcast discovery response message can be encapsulated with an outer destination address and an outer source address. The multicast/broadcast discovery response message can be encapsulated in a tunnel managed by the gateway. The tunnel can be a Generic Routing Encapsulation (GRE) tunnel.

At stage 980, the encapsulated multicast/broadcast discovery response message can be forwarded to the client.

In some embodiments, the multicast/broadcast client can be within a local network behind the gateway and the multicast/broadcast server can be outside the local network (e.g., in a different local network or in a cloud). In some other embodiments, the multicast/broadcast server can be within a local network behind the gateway and the multicast/broadcast client can be outside the local network (e.g., in a different local network or in a cloud).

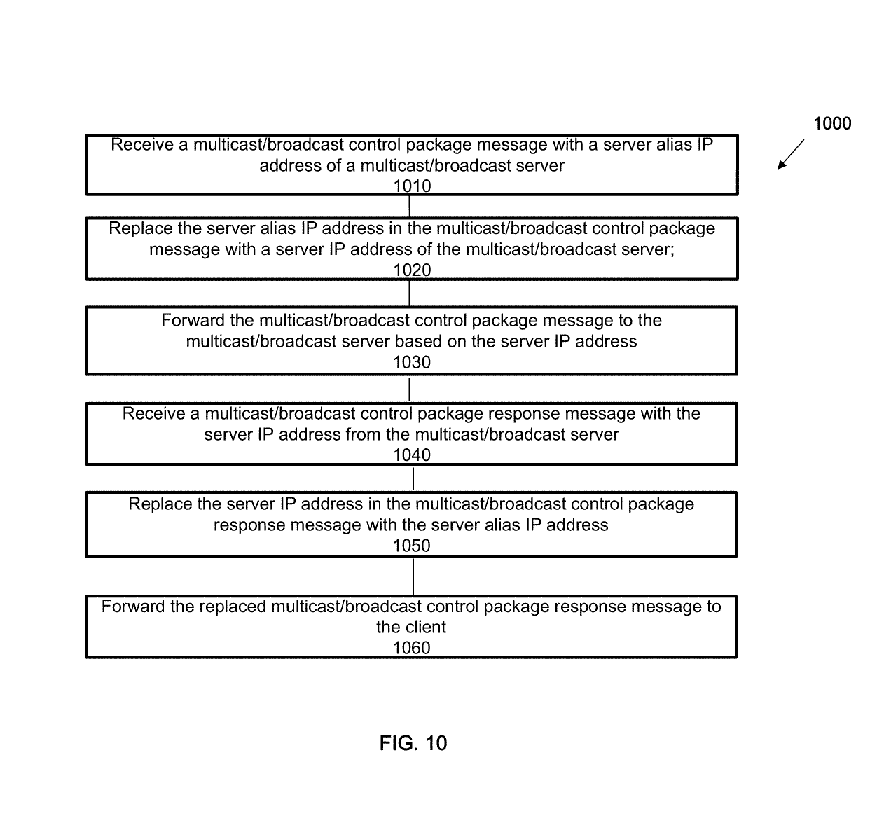

FIG. 10 illustrates an exemplary operation 1000 of a gateway according to certain embodiments of the disclosed subject matter. The operation 1000 can be modified by, for example, having stages rearranged, changed, added and/or removed.

At stage 1010, a multicast/broadcast control package message with a server alias IP address of a multicast/broadcast server can be received from, e.g., a multicast/broadcast client (such as 310 in FIG. 3). In some embodiments, the multicast/broadcast control package message can include a HTTP Get message.

At stage 1020, the server alias IP address in the multicast/broadcast control package message can be replaced with a server IP address of the multicast/broadcast server at, e.g., a gateway (such as 330 in FIG. 3). In some embodiments, the gateway can serve as a multicast/broadcast proxy.

At stage 1030, the multicast/broadcast control package message can be forwarded to the multicast/broadcast server based on the server IP address. In some embodiments, the multicast/broadcast server can be a DLNA server.

At stage 1040, a multicast/broadcast control package response message with the server IP address can be received from the multicast/broadcast server. In some embodiments, the multicast/broadcast control package message can include a HTTP Response message.

At stage 1050, the server IP address in the multicast/broadcast control package response message can replaced with the server alias IP address.

At stage 1060, the replaced multicast/broadcast control package response message can be forwarded to the client.

Optionally, encapsulation (e.g., in a tunnel, such as a GRE tunnel, managed by the gateway) of the multicast/broadcast control package message can be removed before the multicast/broadcast control package message is forwarded to the multicast/broadcast server. Also optionally, the multicast/broadcast control package response message can be encapsulated (e.g., in a tunnel, such as a GRE tunnel, managed by the gateway) with an outer destination address and an outer source address before being forwarded to the client.

In some embodiments, the multicast/broadcast client can be within a local network behind the gateway and the multicast/broadcast server can be outside the local network (e.g., in a different local network or in a cloud). In some other embodiments, the multicast/broadcast server can be within a local network behind the gateway and the multicast/broadcast client can be outside the local network (e.g., in a different local network or in a cloud).

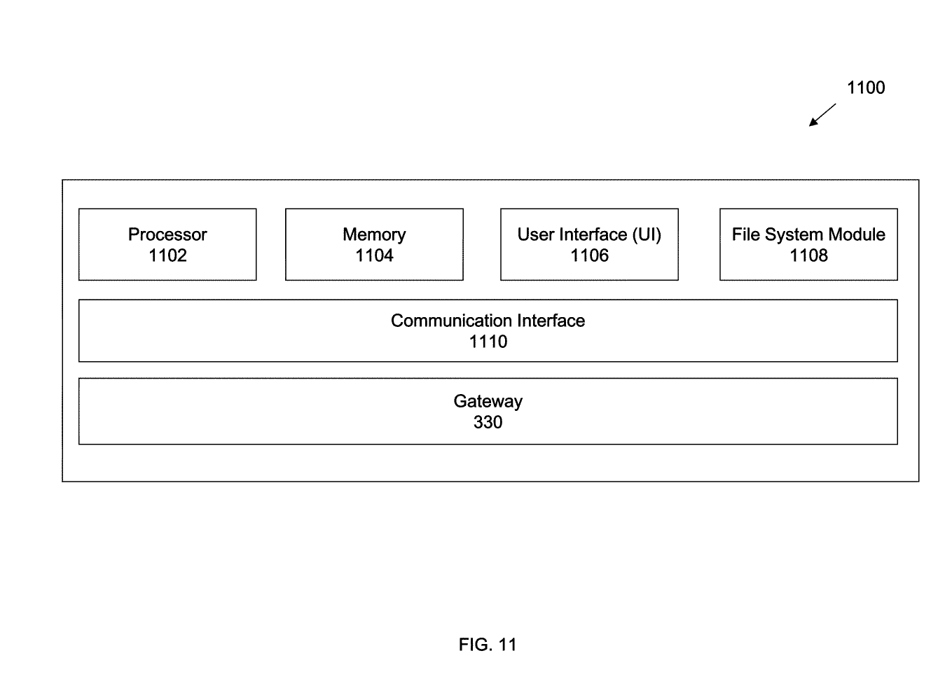

FIG. 11 illustrates a block diagram of an exemplary computing device 1100 according to certain embodiments of the disclosed subject matter. The computing device 1100 can include at least one processor 1102 and at least one memory 1104. The processor 1102 can be hardware that is configured to execute computer readable instructions such as software. The processor 1102 can be a general processor or be an application specific hardware (e.g., an application specific integrated circuit (ASIC), programmable logic array (PLA), field programmable gate array (FPGA), or any other integrated circuit). The processor 1102 can execute computer instructions or computer code to perform desired tasks. The memory 1104 can be a transitory or non-transitory computer readable medium, such as flash memory, a magnetic disk drive, an optical drive, a programmable read-only memory (PROM), a read-only memory (ROM), a random access memory (RAM), or any other memory or combination of memories.

The computing device 1100 can also optionally include a user interface (UI) 1106, a file system module 1108, and a communication interface 1110. The UI 1106 can provide an interface for users to interact with the computing device 1100 in order to access the gateway 330. The file system module 1108 can be configured to maintain a list of all data files, including both local data files and remote data files, in every folder in a file system. The file system module 1108 can be further configured to coordinate with the memory 1104 to store and cache files/data. The communication interface 1110 can allow the computing device 1100 to communicate with external resources (e.g., a network or a remote client/server). The computing device 1100 can also include a gateway 330. The description of the gateway 330 and its functionalities can be found in the discussion of FIGS. 1-10. The computing device 1100 can include additional modules, fewer modules, or any other suitable combination of modules that perform any suitable operation or combination of operations.

In addition, embodiment systems can support standard-based communication protocols and enhanced optimizations for implementation of a Wireless Access Gateway (WAG) for providing IP access services to 802.11 family of Wi-Fi networks, a GPRS Service Node (GGSN) function as specified by 3^{rd} Generation Partnership Project (3GPP) standards in TS 23.002, SGW and PGW as specified in TS 23.401, or PDG as specified in 23.234. An embodiment system can also support standard-based communication protocols for implementation of a PDSN/HA functions as specified by 3GPP2 standards in the CDMA2000 Wireless IP Network Standard (3GPP2 X.S0011-001-E v1.0). An embodiment system can further support standard-based communication protocols for implementation of ASN-GW/HA functions as specified by WiMAX standards in WiMAX Forum Network Architecture (WiMAX Forum Document Number WMF-T32-002-R010v04, Feb. 3, 2009).

The systems and methods described in the disclosed subject matter can be implemented with various network technologies. A Mobile Evolved Gateway (MEG) open programmable mobile internet gateway can perform more than one functions while integrating different functionalities. The MEG open programmable mobile internet gateway can perform as Gateway General packet radio service Support Node (GGSN), GPRS support node (SGSN), mobility management entity (MME), a packet data serving node (PDSN), a foreign agent (FA), or home agent (HA), an HRPD serving gateway (HSGW), a serving gateway (SGW), a packet data network gateway (PGW), an access service network gateway (ASNGW), packet data inter-working function (PDIF), packet data gateway (PDG), or a Wi-Fi gateway. In certain embodiments, one or more of the abovementioned other types of functionalities are integrated together or provided by the same gateway.

The MEG open programmable mobile internet gateway can also support sessions originated from a femto base station or a Wi-Fi access point over a secure connection, which can connect to the MEG open programmable mobile internet gateway using a broadband network. The gateway can provide trigger based traffic management during a handoff from a small cell base station or wi-fi access point to a macro base station, while maintaining traffic management for the mobile node and preservation of IP address. In certain embodiments the gateway is used as offload device to offload traffic off the macro cellular licensed spectrum to femto or Wi-Fi base stations.

The systems described in the disclosed subject matter can be implemented in hardware and/or software. The software can run on multi blade, multi CPU with multiple processing cores. The operating system software can be based on a Linux software kernel and run specific applications in the gateway and providing protocol stacks.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

A “server,” “client,” “agent,” “module,” “manager,” “interface,” and “host” is not software per se and includes at least some tangible, non-transitory hardware that is configured to execute computer readable instructions. In addition, the phrase “based on” does not imply exclusiveness—for example, if X is based on A, X can also be based on B, C, and/or other factor(s).

What is claimed is:

1. A computerized method, comprising:
receiving a multicast/broadcast discovery message from a client;
encapsulating the multicast/broadcast discovery message at a gateway;
forwarding the encapsulated multicast/broadcast discovery message to a multicast/broadcast server;
receiving a multicast/broadcast discovery response message from the multicast/broadcast server with a server IP address;
generating a server alias IP address for the multicast/broadcast server at the gateway;
replacing the server IP address with the server alias IP address in the multicast/broadcast discovery response message;
encapsulating the multicast/broadcast discovery response message at the gateway; and
forwarding the encapsulated multicast/broadcast discovery response message to the client.

2. The computerized method of claim 1, wherein the multicast/broadcast server is a DLNA (Digital Living Network Alliance)-compatible server, the multicast/broadcast discovery message is a DLNA discovery message, and the multicast/broadcast discovery response message is a DLNA discovery response message.

3. The computerized method of claim 1, wherein the multicast/broadcast discovery message is encapsulated with an outer destination address and an outer source address.

4. The computerized method of claim 1, wherein the multicast/broadcast discovery message is encapsulated in a tunnel managed by the gateway.

5. The computerized method of claim 4, wherein the tunnel is a Generic Routing Encapsulation (GRE) tunnel.

6. The computerized method of claim 1, wherein the multicast/broadcast discovery response message is encapsulated with an outer destination address and an outer source address.

7. The computerized method of claim 1, wherein the multicast/broadcast discovery response message is encapsulated in a tunnel managed by the gateway.

8. The computerized method of claim 7, wherein the tunnel is a Generic Routing Encapsulation (GRE) tunnel.

9. The computerized method of claim 1, wherein the client is within a local network behind the gateway and the multicast/broadcast server is outside the local network.

10. The computerized method of claim 1, wherein the multicast/broadcast server is within a local network behind the gateway and the client is outside the local network.

11. A computerized method, comprising:
receiving a multicast/broadcast control package message from a client with a server alias IP address of a multicast/broadcast server;
replacing the server alias IP address in the multicast/broadcast control package message with a server IP address of the multicast/broadcast server at a gateway;
forwarding the multicast/broadcast control package message to the multicast/broadcast server based on the server IP address;
receiving a multicast/broadcast control package response message from the multicast/broadcast server with the server IP address;
replacing the server IP address in the multicast/broadcast control package response message with the server alias IP address; and
forwarding the replaced multicast/broadcast control package response message to the client.

12. The computerized method of claim 11, wherein the multicast/broadcast server is a DLNA (Digital Living Network Alliance)-compatible server, the multicast/broadcast control package message includes a HTTP Get message, and the multicast/broadcast control package response message includes a HTTP Response message.

13. The computerized method of claim 11, further comprising removing encapsulation of the multicast/broadcast control package message.

14. The computerized method of claim 13, wherein the encapsulation is in a tunnel managed by the gateway.

15. The computerized method of claim 14, wherein the tunnel is a Generic Routing Encapsulation (GRE) tunnel.

16. The computerized method of claim 11, further comprising encapsulating the multicast/broadcast control package response message with an outer destination address and an outer source address before forwarding the multicast/broadcast control package response message to the client.

17. The computerized method of claim 16, wherein the multicast/broadcast control package response message is encapsulated in a tunnel managed by the gateway.

18. The computerized method of claim 17, wherein the tunnel is a Generic Routing Encapsulation (GRE) tunnel.

19. The computerized method of claim 11, wherein the client is within a local network behind the gateway and the multicast/broadcast server is outside the local network.

20. The computerized method of claim 11, wherein the multicast/broadcast server is within a local network behind the gateway and the client is outside the local network.

21. A network gateway serving as a multicast/broadcast proxy, comprising:
an access network interface configured to receive a multicast/broadcast message from a client destined to a multicast/broadcast server;
a router network interface configured to forward the multicast/broadcast message to the multicast/broadcast server;
a multicast/broadcast server database containing information about available multicast/broadcast servers;
an address translation module configured to translate between a server IP address and a server alias IP address of the multicast/broadcast server in the multicast/broadcast message; and
an encapsulation module configured to encapsulate the multicast/broadcast message and remove encapsulation from an encapsulated multicast/broadcast message.

22. The network gateway of claim 21, further comprising a configuration manager configured to set up the network gateway.

23. The network gateway of claim 22, wherein the configuration manage is configured to set at least one of a Gateway Access IP address and a Gateway Router IP address.

24. The network gateway of claim 21, wherein the multicast/broadcast message is a multicast/broadcast discovery message.

25. The network gateway of claim 21, wherein the multicast/broadcast message is a multicast/broadcast control package message.

26. The network gateway of claim 21, wherein the multicast/broadcast server is a DLNA (Digital Living Network Alliance)-compatible server.

27. The network gateway of claim 21, wherein the client is within a local network behind the network gateway and the multicast/broadcast server is outside the local network.

28. The network gateway of claim 21, wherein the multicast/broadcast server is within a local network behind the network gateway and the client is outside the local network.
